(19) United States
(12) Patent Application Publication
(10) Pub. No.: US 2011/0228076 A1
(43) Pub. Date: Sep. 22, 2011

(54) Multifunctional monitoring apparatus

(76) Inventor: Da-Ming Liu, Xindian City (TW)

(21) Appl. No.: 12/659,678

(22) Filed: Mar. 17, 2010

(51) Int. Cl. H04N 7/18; G01N 25/00

(52) U.S. Cl. 348/84; 374/6; 348/E07.085

(57) ABSTRACT

A multifunctional monitoring apparatus includes an operating portion, two flexible tubes and two camera modules. The operating portion includes a handle, a controller, a display screen and two connecting ends. The handle provides a grip for users and facilitates the operation of the monitoring apparatus. The controller is connected to the display screen. Each flexible tube is coupled to each connecting end. Each camera module includes a sleeve, a camera and a circuit board. Each camera is installed in each sleeve and connected to each circuit board. Each circuit board is connected to the controller through a transmission line, such that after the controller has received image data captured by the cameras, the image data can be transmitted to the display screen. Users simply need to place the two camera modules at two desired observing locations to observe and compare the environments of two different locations.

### FIELD OF THE INVENTION

The present invention relates to a multifunctional monitoring apparatus, in particular to a multifunctional monitoring apparatus having two camera modules for taking pictures to monitor environments at two different locations, and displaying image data of the pictures through a split screen or a switching screen to facilitate users to observe and compare the environments of the two different locations simultaneously.

### BACKGROUND OF THE INVENTION

In a vast majority of residences, pipelines such as water pipes and gas pipes are installed, and the pipelines (water pipes or gas pipes) are generally buried into a wall or under the floor, such that if any pipeline is damaged, broken or clogged, users (including maintenance personnel) have to locate a position of the wall or the floor corresponding to the problem pipeline and then use a tool (such as a steel chisel, an electric hammer, and an electric drill, etc) to dig a hole in the wall or the floor to confirm the position of the damaged or clogged pipeline. However, users usually cannot locate and find the cause of the pipeline failure at once, but have to dig many holes in the wall or the floor before the problem pipeline can be located and repaired. Obviously, users have to spend much time and efforts to dig the holes, not only causing annoying noises, but also delaying the schedule of the repair work. Furthermore, after the users have completed repairing the problem pipeline, the users have to spend additional time and materials to repair the holes formed on the wall or floor, not only increasing the level of difficulty and the cost of the construction, but also damaging the integrity or the aesthetic look of the wall or the floor.

To overcome the aforementioned problems and avoid digging too many holes in the wall or the floor, related designers and manufacturers developed a monitoring apparatus that can be extended into a problem pipeline to inspect the condition of the pipeline. In FIG. 1, the monitoring apparatus comprises a handle 10, a flexible tube 11, a camera module 12 and a signal line 13, wherein the handle 10 includes a built-in controller 101 coupled to an end of the signal line 13, and a USB port 131 is formed at another end of the signal line 13, such that the signal line 13 can be coupled to a personal computer. An end of the flexible tube 11 is coupled to the handle 10, and the flexible tube 11 is flexible and can be bent and deformed according to the user requirements or the shape of the problem pipeline, and another end of the flexible tube 11 is coupled to the camera module 12.

The camera module 12 includes a sleeve 121, a camera 122 and a circuit board 123, wherein a lens 124 is installed to an upper cover at an end of the sleeve 121, and the camera 122 is installed in the sleeve 121, and the camera 122 is coupled to the circuit board 123, and the circuit board 123 is coupled to a transmission line, and the transmission line is passed through the flexible tube 11 and coupled to the controller 101. If a user wants to use the monitoring apparatus to maintain or repair a pipeline, the user simply needs to dig open the wall or the floor and make an opening on the exposed pipeline, and hold the handle 10 to extend the camera module 12 and the flexible tube 11 into the pipeline through the opening, and then connect a USB port 131 of the signal line 13 to a personal computer, such that the controller 101 can receive the image data of the pictures taken by the camera module 12. The image data are transmitted to the personal compute through the signal line 13 and the USB port 131, such that the user can view the image data of the pictures taken by the camera module 12 from the personal computer, learn about the conditions of the pipeline, and find out the problem of the failed pipeline.

With the aforementioned monitoring apparatus, the user simply needs to dig open the wall or the floor a couple of times to confirm the exact position of the problem pipeline before the repair work takes place, so as to achieve the effects of avoid digging holes in the wall or the floor for too many times, and reducing the time and the cost required for the repair work effectively. If there is more than one position of the problem pipeline, and the positions are coupled and affected by one another, then the user has to know the conditions at both positions simultaneously before the repair work can be done, so that the user has to operate two of the aforementioned monitoring apparatuses at the same time and place the two camera modules 12 and the two flexible tubes 11 at different positions, and connect the two signal lines 13 to two personal computers for confirming the conditions inside the pipeline. In this case, the user has to hold two handles 10 by both hands respectively, and observe the image data displayed on the two personal computers simultaneously, and thus the user does not have a spare hand to do any other work (such as unclogging or patching a pipeline), and thus the application of the conventional monitoring apparatus is very inconvenient. Furthermore, users have to buy two monitoring apparatuses for the foregoing job, and thus incurring a higher expense. Obviously, the conventional monitoring apparatus requires improvements.

Some users may use the monitoring apparatus for repairing automobiles, and the monitoring apparatus is provided for users to observe the internal structure of a motor vehicle and confirm the conditions of the motor vehicle. However, if a user wants to compare the conditions of two different positions inside the motor vehicle, the user not only needs to observe the image data displayed on two personal computers, but also needs to operate the two monitoring apparatuses by both hands, such that the user cannot perform any other work, and the application of such conventional monitoring apparatus is very inconvenient.

Therefore, it is an important subject of the present invention to overcome the shortcomings of the conventional monitoring apparatus and improve the convenience of using the monitoring apparatus, so that users can use the monitoring apparatus to compare image data of pictures taken at two different positions simultaneously.

### SUMMARY OF THE INVENTION

In view of the aforementioned shortcomings of the prior art, the inventor of the present invention based on years of experience in the related industry to conduct extensive researches and experiments, and finally developed a multifunctional monitoring apparatus to improve the convenience of using the monitoring apparatus and waive the cost of purchasing an additional monitoring apparatus.

Therefore, it is a primary objective of the present invention to provide a multifunctional monitoring apparatus comprising an operating portion, two flexible tubes and two camera modules, wherein the operating portion includes a handle, a controller, a display screen and two connecting ends, and the handle is provided for users to grip and facilitating the operation of the monitoring apparatus, and the controller is coupled to the display screen, and an end of each flexible tube is coupled to each connecting end (either by soldering or by screwing), and each camera module includes a sleeve, a camera and a circuit board. An end of each sleeve is coupled to another end of each flexible tube, and another end of each sleeve includes a lens installed thereon. Each camera is installed in each sleeve and at a position corresponding to each lens for capturing image data outside each lens, and each camera is coupled to each circuit board. Each circuit board is coupled to a transmission line. Each transmission line is passed through each flexible tube, extended and passed through each connecting end, and coupled to the controller, such that after the controller has received image data transmitted from the cameras, the image data are transmitted to the display screen and displayed on the display screen. In the present invention, users need not to connect the monitoring apparatus to another display device (such as a computer or a liquid crystal display, etc) for viewing the image data through the display screen. More importantly, the monitoring apparatus includes two cameras, so that users simply need to place the two camera modules at two desired observing locations in order to observe and compare the environments of two different locations simultaneously from the display screen, without the need of purchasing two monitoring apparatuses, so as to save the user's expense effectively. In addition, a user just needs to hold the handle by a hand to operate the monitoring apparatus, and thus the user still has another hand available for doing other work. Instead of operating two conventional monitoring apparatuses by both hands, the present invention can improve the convenience of using the monitoring apparatus.

Another objective of the present invention is to install at least one light emitting element at a position corresponding to each circuit board, such that even if each camera module is placed in a dark space, each camera module still can take pictures of the observed location by the light emitted from each light emitting element, and transmit the image data of the pictures to the controller.

A further objective of the present invention is to install an input interface (such as a press button or a keyboard) on the operating portion, wherein the input interface is coupled to the controller for transmitting a switch signal to the controller to switch the display mode of the display screen, such that the display screen can display the image data by split screens or switching screens, and users can control the input interface to select a desired display mode.

### BRIEF DESCRIPTION OF THE DRAWINGS

FIG. 1 is a schematic view of a conventional monitoring apparatus;

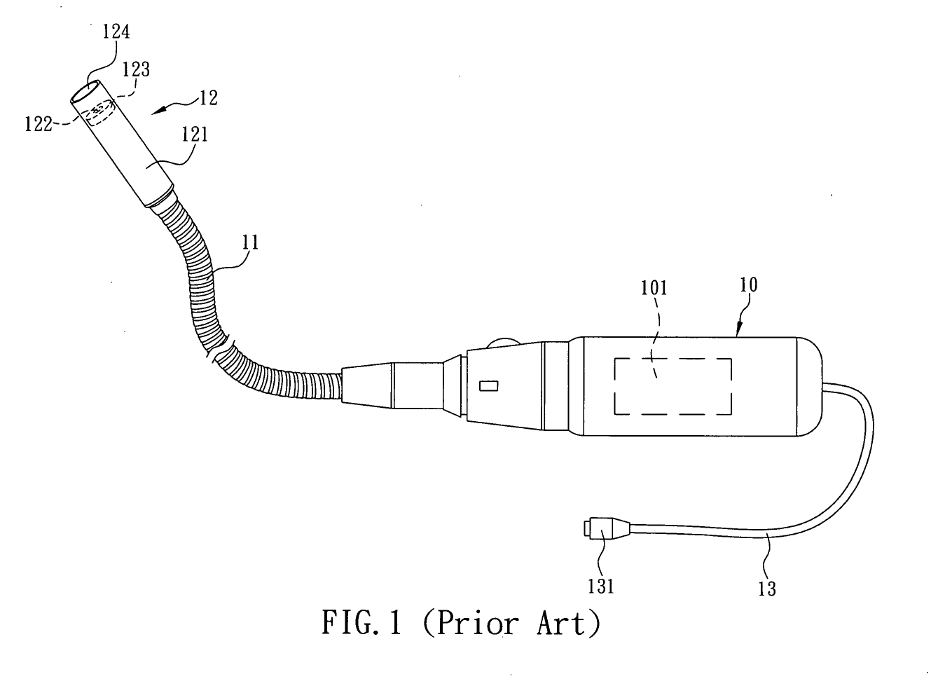

FIG. 2 is a schematic perspective view of a monitoring apparatus in accordance with a first preferred embodiment of the present invention;

FIG. 3 is a partial enlarged view of a monitoring apparatus in accordance with a first preferred embodiment of the present invention; and

FIG. 4 is a schematic perspective view of a monitoring apparatus in accordance with a second preferred embodiment of the present invention.

### DETAILED DESCRIPTION OF THE PREFERRED EMBODIMENTS

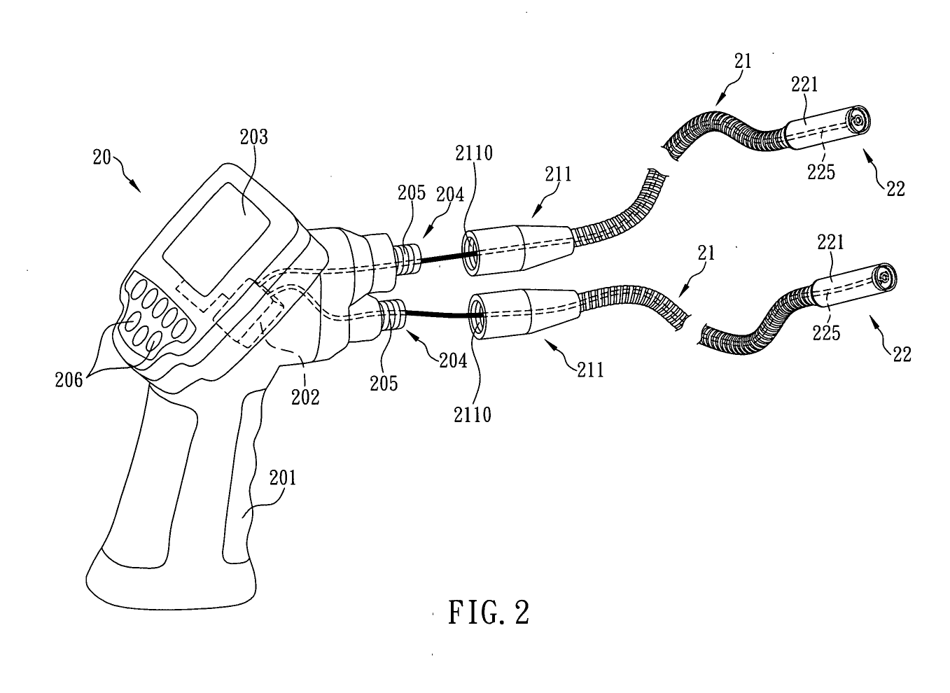

With reference to FIG. 2 for a schematic perspective view of a multifunctional monitoring apparatus in accordance with a first preferred embodiment of the present invention, the monitoring apparatus comprises an operating portion 20, two flexible tubes 21 and two camera modules 22, wherein the operating portion 20 includes a handle 201, a controller 202, a display screen 203 and two connecting ends 204. The handle 201 provides a grip for users to facilitate operating and using the monitoring apparatus. The controller 202 is installed in the operating portion 20. The display screen 203 is coupled to the controller 202. Each connecting end 204 has a screw thread 205 formed on an external surface of the connecting end 204. An end of each flexible tube 21 is coupled to an end of a connecting sheath 211, and a screw thread 2110 is formed on an internal side of another end of each connecting sheath 211, and each connecting sheath 211 is coupled to each connecting end 204 through the screw threads 205, 2110. It is noteworthy to point out that the present invention is not limited to such arrangement only, but manufacturers also can connect each flexible tube 21 to each connecting end 204 by a soldering or adhesion method for manufacturing the monitoring apparatus.

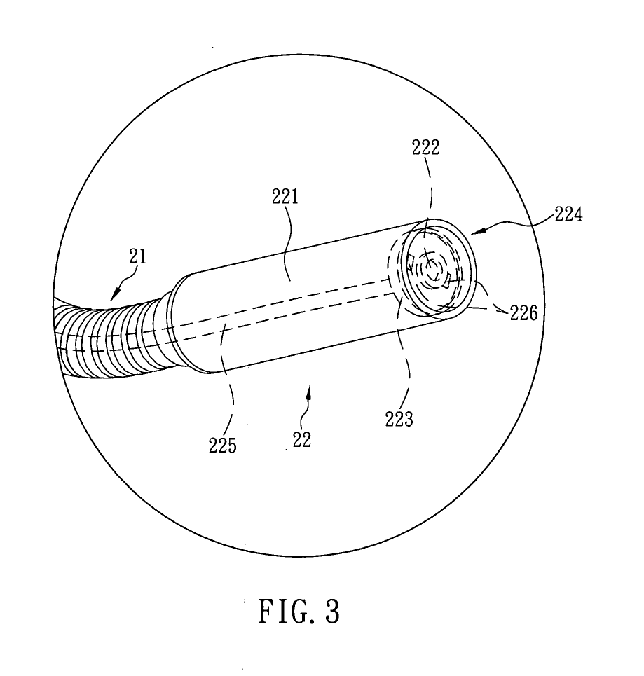

With reference to FIG. 3, each camera module 22 includes a sleeve 221, a camera 222 and a circuit board 223. An end of each sleeve 221 is connected to another end of each flexible tube 21 (by soldering or screwing). A lens 224 is installed and covered onto another end of each sleeve 221, and each camera 222 is installed in each sleeve 221 and at a position corresponding to each lens 224 for capturing image data of pictures outside each lens 224, and each camera 222 is coupled to each circuit board 223. In FIGS. 2 and 3, each circuit board 223 is coupled to a transmission line 225, and each transmission line 225 is passed through each flexible tube 21, extended to each connecting end 204, and coupled to the controller 202. After the controller 202 has received the image data transmitted from the cameras 222 through the transmission lines 225, the image data are transmitted to the display screen 203, so that the display screen 203 can display the image data. When a user repairs a pipeline or fixes a motor vehicle and wants to observe the conditions of two different locations simultaneously, the user just needs to place the two camera modules 22 at two different desired observing locations and holds the handle 201 by a hand to observe and compare the image data through the display screen 203. Since users need not connect two conventional monitoring apparatuses to two personal computers, or hold the two monitoring apparatuses by two hands simultaneously, therefore the users can have a spare hand to carry out another job, not only improving the convenience of using the monitoring apparatus effectively, but also saving the cost of purchasing two sets of conventional monitoring apparatuses.

In the first preferred embodiment as shown in FIG. 3, two light emitting elements 226 are installed on each circuit board 223 and separately at a position corresponding to each lens 224, wherein the light emitting elements 226 are light emitting diodes (LED). However, the present invention is not limited to such arrangement only, but manufacturers can increase or decrease the quantity of light emitting elements 226 according to the design or actual requirement for the manufacture of the monitoring apparatus, or adopt laser diodes or other lamp devices as the light emitting elements 226.

Even if each camera module 22 is placed in a dark place (such as inside a pipeline or a motor vehicle), each camera module 22 still can take the picture of a desired observing location by the light emitted from the light emitting elements 226 and transmit the image data of the picture to the controller 202. In other words, the controller 202 can transmit the image data to the display screen 203 for the user's view.

In the first preferred embodiment as shown in FIG. 2, the operating portion 20 further includes an input interface 206, which is a set of press buttons, connected to the controller 202, and provided for transmitting a change signal to the controller 202 to change a display mode of the display screen 203, so that the display screen 203 can display image data by a split screen method or a switching screen method. Users can control the input interface 206 to select the desired display mode. If a user wants to compare the image data of pictures taken by each camera module 22, the user can use the input interface 206 to switch the display screen 203 into split screens. If the user wants to observe the image data of pictures taken by each camera module 22, the user can use the input interface 206 to switch the screen and select the desired viewing image data. Obviously, the present invention improves the convenience of operating the monitoring apparatus. In addition, manufacturers can design and add a waterproof structure to the monitoring apparatus of the present invention according to the requirements of a practical application, such that the monitoring apparatus can be used at a wet place or in water.

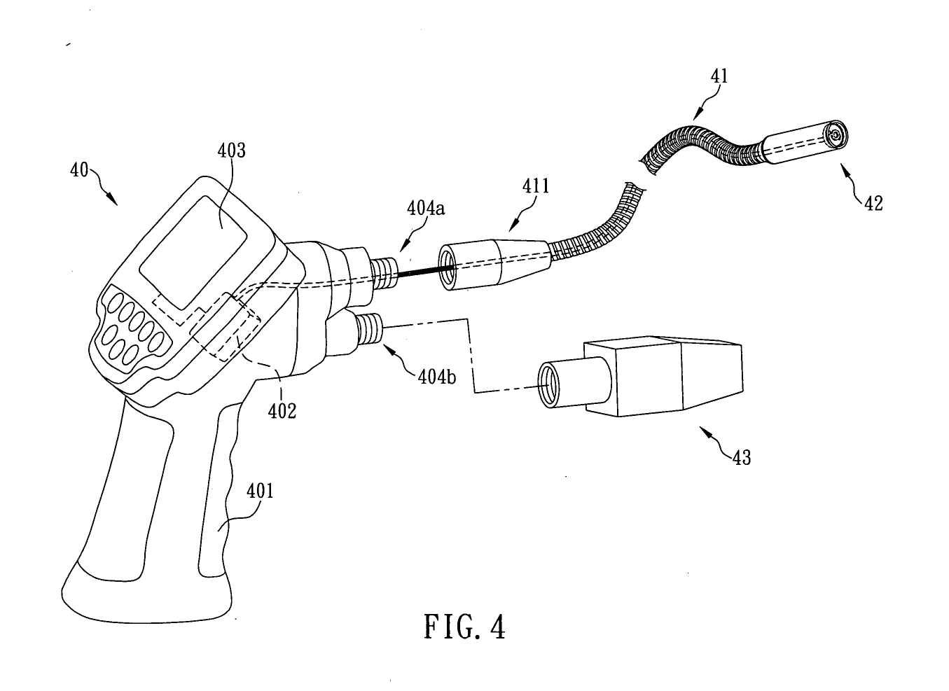

With reference to FIG. 4 for a second preferred embodiment of the present invention, the monitoring apparatus comprises an operating portion 40, a flexible tube 41, a camera module 42 and a temperature measuring instrument 43. The operating portion 40 includes a handle 401, a controller 402, a display screen 403, a first connecting end 404a and a second connecting end 404b. The controller 402 is installed in the operating portion 40, and the display screen 403 is coupled to the controller 402, and an end of the flexible tube 41 is coupled to an end of a connecting sheath 411, and another end of the connecting sheath 411 is coupled to the first connecting end 404a. In addition, the temperature measuring instrument 43 is coupled to the second connecting end 404b (by a screw connection method), and the temperature measuring instrument 43 is electrically coupled to the controller 402 through the second connecting end 404b. When a user takes a picture by the camera module 42, the user, if needed, may use the temperature measuring instrument 43 to measure the temperature of a testing object. The present invention is not limited to such arrangement only, but manufacturers can replace the temperature measuring instrument 43 by another device such as a distance measuring instrument or a hygroscope according to the actual design requirements for measuring other ambient parameters. In addition, a wireless transceiver can be installed to the second connecting end 404b, such that the monitoring apparatus can receive other image data of pictures captured the monitoring apparatus via a wireless connection.

While the invention has been described by means of specific embodiments, numerous modifications and variations could be made thereto by those generally skilled in the art without departing from the scope and spirit of the invention set forth in the claims.

What is claimed is:

1. A multifunctional monitoring apparatus, comprising:
an operating portion, including a handle, a controller, a display screen, a first connecting end and a second connecting end installed therein, wherein the handle is provided for a user to grip, and the controller is coupled to the display screen;
a flexible tube, with an end coupled to the first connecting end;
a camera module, including a sleeve, a camera and a circuit board, wherein an end of the sleeve is coupled to another end of the flexible tube, another end of the sleeve includes a lens, and the camera is installed in the sleeve at a position corresponding to the lens for capturing image data outside the lens, the camera is coupled to the circuit board, the circuit board is coupled to a transmission line, the transmission line is passed through the flexible tube, extended to the first connecting end and coupled to the controller, such that after the controller has received the image data transmitted from the cameras, the image data can be transmitted to the display screen; and
a sensing unit, electrically coupled to the controller through the second connecting end.

2. The monitoring apparatus of claim 1, wherein the sensing unit is formed by another flexible tube and another camera module.

3. The monitoring apparatus of claim 2, wherein the operating portion includes an input interface thereon, and the input interface is capable of sending a change signal to the controller to change a display mode of the display screen, such that the display screen can display the image data by a split screen method or a switching screen method.

4. The monitoring apparatus of claim 3, wherein the circuit board includes at least one light emitting element installed at a position corresponding to the lens.

5. The monitoring apparatus of claim 4, wherein the light emitting element is a light emitting diode.

6. The monitoring apparatus of claim 4, wherein the light emitting element is a laser diode.

7. The monitoring apparatus of claim 1, wherein the sensing unit is a temperature measuring instrument.

8. The monitoring apparatus of claim 1, wherein the sensing unit is a distance measuring instrument.

9. The monitoring apparatus of claim 1, wherein the sensing unit is a wireless transceiver.
